(19) United States
(12) Patent Application Publication
(10) Pub. No.: US 2017/0169513 A1
(43) Pub. Date: Jun. 15, 2017

(54) METHOD AND SYSTEM OF PREPAID VOUCHERS WITH TIME CONDITIONAL VALUE

(71) Applicant: Mark Perelman, New York City, NY (US)

(72) Inventor: Mark Perelman, New York City, NY (US)

(21) Appl. No.: 15/369,665

(22) Filed: Dec. 5, 2016

Related U.S. Application Data
(60) Provisional application No. 62/267,831, filed on Dec. 15, 2015.

(51) Int. Cl. G06Q 40/04; G06Q 40/06; G06Q 40/00; G06Q 40/02

(52) U.S. Cl. CPC G06Q 40/04; G06Q 40/02; G06Q 40/06; G06Q 40/12

(57) ABSTRACT

A method for the trading and accessing prepaid vouchers with time conditional value between a consumer and a vendor (primary market) and between consumers (secondary market).

A host platform with interfaces for merchants and consumers that allow for the execution and trading of such contracts as well as for the associated functionality, including the presence of targeted marketing by vendors. Additionally, the consumer interface allows for the establishment of a customizable consumer profile which contains a budget (including gift or shopping preferences and a calendar of important dates), a linkage to a social network and an array of interface templates.

### BACKGROUND

There is a need for alternative types of financial services that provide consumers with potentially high yielding savings account-like instruments. Patent have been granted for computer-based systems (including related technologies such as smart phones, tablets, and so on) that allow consumers to create budgets and wish lists, save for particular purchases (digital layaway contracts), and enter into group purchases.

Fundamental economic practices and prior art, however, have not linked consumers directly with the ultimate vendor, as a counterparty, in a contract with ex ante interest rates (or discount, return rates) that depended on when the consumer(s) receives the desired good or service. This improvement is not obvious as it hitherto has not been used in trade with or without computational technologies. By linking consumers and vendors together and structuring a time dependent contract, the current system overcomes problems for both consumers' (i.e. low return savings vehicles, few incentives to budget, etc.) and vendors (i.e., directing sale actualization time and place, immediate access to funds, gaining wallet share, etc.).

Financial theory for those wishing to save or invest advises them to take on no more risk than they can bear. Unfortunately, those with the least wealth are also able to take on the least risk. If the equity market falls, the only place to turn for even short-term financing may have exorbitant interest rates. The generally decreasing interest rate environment over recent history is leading to fixed income products that have low interest rates; while high yield (junk) issues face similar problems to the equity market. The primary choices are commercial savings accounts with low yields—and at times restrictions and fees that weigh disproportionally heavily on lower income consumers that most use these accounts.

Commercial banks see the poor as unattractive investments and many younger adults 18-29 (Generation Y) have become increasingly distrustful of them. Some banks more than others are trying to court the underserved using alternative sources of finance. Allowances, such as from parents to teenagers, can currently be funneled through services such as OINK and VISA's Buxx, teaching basic finance while remitting in a controlled manner. Banks and credit card issuers are issuing specially branded prepaid cards designed distance from their ‘ordinary’ offerings; these include RushCard by VISA, Liquid by CHASE, BlueBird by AMERICAN EXPRESS, and so on. This is seen as less risky to the issuers but isn't really that big a benefit to consumers (aside from holding a card instead of cash).

Christmas Club Accounts are special short-term savings accounts set up by financial institutions to encourage nest-egg building for the holidays. Most can be opened with a nominal deposit. Although they reached their height of popularity in the 1970s, nearly 72 percent of credit unions run Christmas clubs today according to the Credit Union National Association. SMARTYPIG updates the Christmas Club Account concept through a savings platform that allows its customers to establish multiple goals. The consumer can have separate goals and fund them with different amounts at time intervals that keep you in control with the ability to track progress. A social media component allows friends and family to fund those goals and view progress. SMARTYPIG has strategic alliances with a bank (first West Bank and now BBVA Compass) that allow consumers to earn interest at the bank's rate; while the rate started off being high relative to peers it has since fallen to average. The consumer can retrieve funds for a discount with select vendors or at value with a credit card or bank deposit. There are several core weaknesses in SMARTYPIG's approach:
a. People aren't bound to their goals and don't have any incentive to schedule these goals. These ‘goals’ seem more similar to wish lists for unneeded items.
b. The interest rate is paid (by the bank) no matter what the funds are used on or when. There's little rationale for this rate to be competitive.
c. The only additional discount available to consumers that reach their goal and want to shop at one of the select merchants is up to 5% off gift cards. These gift cards are mailed and subject to the same problems as other gift cards (see gift card section below).

There are additional financial products that should be mentioned because they bare some similarities to this patent. Certificates of Deposit (CDs) are time deposits (similar to savings accounts) but restrict holders from withdrawing funds on demand for a set period (generally from a month to a five years). Although it is still possible to withdraw the money, this action will often incur a penalty. In exchange for keeping the money on deposit for the agreed-on term, institutions usually grant higher interest rates than they do on accounts from which money may be withdrawn on demand. These rates can either be fixed at the time of issue or variable in that they may adjust to the prevailing rates. In recent times these rates have been low due to the interest rates environment.

High finance, used by sophisticated investors, involves combining assets with their derivatives¹, such as protective puts², but these types of products are not well understood by the general public—as has been demonstrated by losses during the Great Recession. ¹Forward contracts (and standardized futures) are contracts between two parties to buy or to sell an asset at a specified future time at a price agreed upon today. The price agreed upon is called the delivery price, which is equal to the forward price at the time the contract is entered into. Option contracts (warrants) give the buyer (the owner or holder) the right, but not the obligation, to buy or sell an underlying asset or instrument at a specified strike price on or before a specified date, depending on the form of the option. The strike price may be set by reference to the spot price (market price) of the underlying security or commodity on the day an option is taken out, or it may be fixed at a discount or at a premium. The seller has the corresponding obligation to fulfill the transaction—that is to sell or buy—if the buyer (owner) “exercises” the option. An option that conveys to the owner the right to buy something at a specific price is referred to as a call; an option that conveys the right of the owner to sell something at a specific price is referred to as a put.²A married put (protective put) is the combination of owning assets (such as stocks or bonds) and enough put options to cover those assets. The term “protective put” highlights the use of this strategy as a hedge, or insurance, against selling the asset below the strike price of the put. In the event that the put is not exercised (because the asset price is above the strike price), the buyer has lost only the premium he paid for the put.

While traditional finance is described by neoclassical economics, people are better described by behavioral economics. Modern portfolio theory (“MPT”) holds that an optimum portfolio is one that gets the most return for every unit of risk; if it does, it is considered to be on the efficient frontier. On the other hand, Goal Based Investing (“GBT”, also known as Goal Driven Investing, Layering, or Envelope System) is a money-saving strategy using “mental accounts,” where each financial goal is funded and invested independently. Each goal, because it has a unique time horizon, has its own asset allocation and its own risk profile. Using this approach, performance is measured by the success of investments in meeting an individual's personal and lifestyle goals. This differs from the conventional investing methodology where financial performance is defined as a return against an investment benchmark. This approach results in focus of the investment approach shifting from achieving a higher returns approach to the investment, or exceeding the market returns approach to funding a personal financial goals approach.

While MPT supports decentralized investment in an attempt to maximize returns per level of risk, GBT supports buyers contracting directly with sellers. Such services include discounts, layaway, scrips, prepaid cards, and wish lists. In using such techniques to increase sales, vendors need to minimize price and brand dilution.³ ³“Generally, price dilution describes a situation in which a reduction of a product's price decreases demand for the product at a higher price. In more detail, discounting a price of a product causes potential customers to believe that the discounted price is the “correct” price of the product, and therefore the customers become unwilling to accept any higher price for the product. Accordingly, conventional discount pricing systems can negatively affect future profits generated by a product. Conventional discount pricing systems can also lead to brand dilution. Brand dilution refers to a reduction in the prestige of a brand in the minds of consumers. In this regard, conventional publicized price discounts for a product of a particular brand tend to reduce the amount of prestige which consumers attribute to the brand. Since brand prestige, or “goodwill”, is a valuable asset vigorously protected by successful manufacturers (e.g., via trademark protection), these manufacturers are reluctant to allow retailers to discount prices for their products or to advertise the discounted prices. As a result, it is difficult for retailers to reduce excess inventory of these products.” [SOURCE: http://www.google.com.tr/patents/US20070208625]

Brick-and-mortar retailers have long depended on coupons and loyalty programs for marketing. The quick rise of EBAY and AMAZON was followed by the rise of deal sites such as GROUPON, COUPONS.COM, SAVINGSTAR and RETAILMENOT. These sites extend the reach and appeal of brick-and-mortar retailers by modernizing the coupon and loyalty program concepts and collecting them in one place.

The competition in this segment is fierce and profit margins are decreasing to the point that any fixed costs, including physical locations, are becoming liabilities. The sheer volume of choice and pace of change are dizzying and force current consumption rather than saving. As consumers have faced a painful deleveraging, their appetite to rush back to rapid purchases (even if discounted) may take awhile to return. Furthermore, many of these are flash deals that encourage impulse buying—which has a higher rate of product return. There is a lot of prior art dealing with loyalty programs where consumers accumulate rewards for purchase history and redeem for vouchers (i.e. gift certificate or card) or choice of items (i.e. from a reward catalogue); these however are incremental for past sales and rewarding of delayed purchases.

SHOPKICK encourages consumers to go into stores (in order to get discounts). The idea here is that merchants get marketing and an opportunity to impress their customers. The consumer isn't piqued to time their purchase—this is essentially a mobile version of a discount catalog that consumers can pick up at the store, but saves the merchant the cost of printing it.

GROUPON and other group-based promotions primarily target small businesses. The consumer pays a fee to buy a temporary deal for a discounted future purchase made within a given time period; usually the deal is ‘on’ only if enough people purchase it. As these are flash deals for future purchases, consumers can change their minds after paying for the deal; however, the system makes refunds difficult and does not create a market for previously purchased deals. As there no time terms (other than expiry), it is possible that consumers use their deals at the same time. This unstaggered influx of redemptions sometimes overwhelms the small business and lead to poorer service. The combination of these things can damage the brand instead of providing the intended marketing.

TRIALPAY which enables customers to pay for one item by trying or buying something else. Their system is used by merchants like Skype to provide consumers with free trials in exchange for participating in deals from their advertising partners. PC World noted that the service seemed to encourage people “to get products they don't really need by trying out other products they don't really need.” The placement of the discount on something other than what the consumer is buying is at best sometimes marginally useful.

Layaway accounts, offered in various forms for years take advantage of merchant promotional offers but are inflexible in payments and merchandise received. Consumers have to decide what they want ahead of time and risk paying penalties if they change their mind or require short-term financing. A major benefit is that they encourage budget creation and saving for a goal. ELAYAWAY and others (US 2012/0046958 A1; US 2010/0138287 A1) modernize the layaway concept to be more flexible but it still low yielding and focused on particular products rather than vendors. The program has several drawbacks:
a. Store specific: Policies differ greatly among retailers in terms of features, which confuses consumers.⁴ They also lack economies of scale (except for Walmart) and so usually have administrative fees and other expenses. ⁴See 5 major retailer's policies: http://www.creditcards.com/credit-card-news/layaway-elayaway-credit_cards-1280.php#chart
b. Item specific: Each layaway account is for a single item instead of giving the consumer choice. This creates higher administrative and inventory costs to vendor. Meanwhile, the buyer does not always know what item she will want or what someone else will want if she intends to give this as a gift; the concept of layaway might have made more sense in the 1930s at a time when products evolved slowly—but makes little sense now that big ticket items change frequently.
c. Time Specific: There are restrictions on when one can enter or complete (pick-up) their account. Most programs require pick-up in time for the December holidays, and so cannot be scheduled for other holidays (such as a birthday in March).
d. Penalties: Due to costs incurred by the program to vendors, the policies usually have some sort of strings. These may include fees on entering into a layaway contract, canceling it, or paying it off too slowly. These fee policies are inconsistent across stores and lead to a lack of trust among consumers.
e. Lack of benefits to vendor: While the vendor makes a sale, they do not know when they can realize it as the payoff schedule is up to the consumer.

Traditionally, layaway requires prepayment directly to the merchant. Several firms link the planning aspects of layaway with a particular store with depositing funds with a financial institution. SMARTYPIG (US 2013/0297450 A1; US 2013/0262237 A1; US 2013/0297470 A1), INSPIRAVE (WO2015077689 A1), and others (US20050222951 A1, US20090063332 A1) implement various versions of such plans. These approaches suffer from some of the same drawbacks as layaway, but, moreover, do not provide much incentive for the merchant or financial institution to provide an above average yield (or discount/interest rate). The consumer may renege at any time and receives a constant rate of return without time-dependency and so is not incentivized to transact at a time preferable to the merchant. Furthermore, as the merchant does not hold the funds, there is no access to working capital.

Scrip (sometimes called chit) is a term for any substitute for legal tender. Scrips were created as company payment of employees under the truck system and also as a means of local commerce in times where regular currency is unavailable. These are a poor store of value as they do not form legal contracts and have limited uses and hence typically trade at a discount.

Likewise, prepaid cards are often inefficiently designed to limit the scope of money; whereas the cash used to purchase them can be used to purchase anything and anytime, the resulting card can have limitations on use and timing. There are no standards and merchants/issuers are able to do what they want. This lack of control has resulted in legislation to tame the market somewhat by state and federal legislation. The main players in this market are BLACKHAWK NETWORK, GREENDOT, and NETSPEND as well as traditional banks (AMERICAN EXPRESS, CHASE, and VISA) and distribute their cards through pharmacies and others. Discount retailers, such as COSTCO, EBAY, and AMAZON, sell a wide variety of prepaid closed loop cards sometimes at a discount. The prepaid/gift card market is segmented into open loop (to be used anywhere) and closed loop (to be used with only one vendor). These are very diverse in terms of fees and use-by dates and have been criticized by regulatory agencies and consumer protection groups for being expensive and/or inflexible with no added benefit of the time value of money. GREENDOT, for example, charges fees for the purchasing and reloading of a prepaid card as well as monthly maintenance fees—why not just use cash then?

Closed loop cards have a higher chance of being unwanted or unused and there are few services that allow exchange or aggregation. CASHSTAR and APPLE's PassBook can serve as a digital wallet for some gift cards—something that works only for e-gift cards. Secondary markets EBAY and CARDCASH act as exchanges for cards with and without middlemen, respectively. High trading cost and product differentiation (variation in card features, use, and laws) make for a weak market—a unified approach may increase information and liquidity. Also, the vendor issuer in these cases can only make rough estimates of card usage timing.

Wish lists are many-to-one type gifting arrangements and can be shared with other consumers exist and can be created at stores in other ways (i.e. registries for weddings), however, it is often not possible to schedule ahead of time, search through several consumers, dynamically update, or is very event specific. In other words, if I want to pick birthday presents for two different friends, chances are that I will not find lists in one place. The biggest problem with these is that they are usually not discounted so they end up being a constrained version of cash that may be laden with fees and expiration dates. What is the point of making cash less valuable?

AMAZON's Wish list capability is one list that has not taken off, perhaps because AMAZON has not encouraged a social network or because there's no system to keep track of what has been purchased from a list for that person. ELFSTER, on the other hand, is a social networking website for wish lists and gift-giving, and organizer for “secret Santa” style gift exchanges. While it has a social aspect, it does not combine it with a shopping or discounting service. DOWNPAYMENTDREAMS extends gifting digitally to wedding registries and payments towards a house. GOFUNDME goes to the next level by using crowd funding for basically anything. Finally, CROWDTILT allows social groups to save for group events.

At the same time, vendors have their own costs and goals. First, they often need short-term financing to manage working capital. For this they turn to the financial markets for everything from short-term certificates of deposit to long-term bonds to revolving lines of credit. Second, they spend a lot on marketing, advertising, and other promotions. Hence, vendors can use some sort of financing arrangement that smoothes out sales and decreases outside marketing expenses. Third, many vendors have sales (business) cycles that they do not manage with subscription services or other types of unearned revenue; these cycles, even in the short-term, can lead to hardships for employees and access to financing. This last pain point can be expanded.

Structural changes are affecting brick and mortar stores (with large fixed costs) which have been severely hit as consumers choose lower cost internet shopping instead of driving out to malls—but consumers return when they see value. Stores use different types of promotions, including discounts (discussed previously) in an attempt incentivize consumers and increase sales. Cyclical factors, such as the business cycle, weather, seasonality, etc. present additional sales risk to vendors. Cold winter months keep people away from Walmart and Macy's in such large numbers that their overall revenues fall (despite internet services and regional diversification).⁵ ⁵http://www.renters.com/article/2014/05/14/us-macys-results-idUSBREA4D0B420140514; http://www.reuters.com/article/2014/05/15/us-walmart-results-idUSBREA4E0BZ20140515

Seasonality is a large factor in the operations of many vendors. Operations, especially those of brick & mortar, requires investments in inventory, marketing (advertising and promotion), and labor to meet demand. Over forecasting leads to a large sunk cost, while under shooting leads to unrealized sales and a loss of consumer good will. Apparel and department stores, have sales to try and manage the demand. A retailer may have 45% of all its sales in November and December, with no more than 10% of its sales in any other month. Successful promotional sales can increase demand at one point and also try to even out the sales cycles. These sales usually involve large groups of lower margin customers that take employees' attention away from higher margin customers (especially if there are limited amounts of desirable discounted merchandise) and decrease customer loyalty. The ability to spread out these sales discreetly can reduce costs and benefit all parties.

Some businesses currently use peak-load pricing, particularly utilities, restaurants and travel to manage sales risk. At off-peak times, there is plenty of spare capacity and marginal costs of production are low (the supply curve is elastic). At peak times when demand is high, short run supply becomes relatively inelastic as the supplier reaches capacity constraints. A combination of higher demand and rising costs forces up the profit maximizing price. Due to sticky pricing, businesses can use discounts off of peak prices to differ prices, constrain marginal costs, and increase profits.

Another pain point that marketing experts call “an important and necessary part of the exchange process between companies and customers”⁶ are product returns. Stringent policies decrease customer loyalty while loose policies can lead to losses. Return rates in 2013 were 10.10% of sales and the retail categories with the highest rates are department stores (16.5%), apparel (10%), home and improvement (11.2%); more so a 2011 survey found that one-third (35.5%) of gift recipients, return at least one gift item.⁷ Vendors (or consumers) have to pay the costs that go into processing a returned and repaired/repackaged product, including processing fees, warranty costs and liquidation. An Accenture survey of electronic research found that only 5% of returns are related to actual product defects. While 27% reflect “buyer's remorse,” 68% of returned products are characterized as “No Trouble Found.” This means that, despite the customer perceiving a fault, no failure was detected when retailers and manufacturers tested against their specifications. It has been found that pre-purchase product research decreases propensity to return while impulse buying increases it. Prepaid purchases allow for greater planning and may decrease costs for stores. ⁶J. Andrew Petersen & V. Kumar (2009) Are Product Returns a Necessary Evil? Antecedents and Consequences, See for a review on return practices.⁷Annual “Customer Returns in the Retail Industry” surveys. http://www.theretailequation.com/retailers/IndustryReports

Subscription models have grown rapidly in recent years—venture capital firms invested over $650 m in 39 subscription based ecommerce firms between January 2014 and March 2015.⁸ Subscription plans typically have “free-to-pay conversion” billing whereby the customer is offered a free trial period for a given product or service, and if the customer does not cancel before the end of the trial period, the model converts to “negative option billing” after the applicable trial period expires and the consumer is charged the applicable product or service fee until they cancel. Analyses of this model find that firms focus on growth with expensive customer acquisition (the free trial) but 72% of customers don't renew within six months of their initial transaction and profits aren't realized.⁹ By reducing the churn rate, firms can increase retention and average customer lifetime value and profits. Subscription models have some attractive qualities that traditional firms would benefit from including ease of selling to existing customers, increased profitability, and decreased marketing expenses.¹⁰ ⁸http://www.slideshare.net/Tracxn/tracxn-subscription-commerce-march-2015⁹http://retentionscience.com/subscription-ecommerce-marketing-preventing-customer-chum/¹⁰http://www.forbes.com/sites/alexlawrence/2012/11/01/five-customer-retention-tips-for-entrepreneurs/#b9fbd3017b0b

Many of current so-called ‘fintech’ developments revolve around money transfer rather than asset management. PAYPAL, VENMO (i.e. US 2011/0137789 A1), APPLE's ApplePay allow for easy transfer of funds (to other consumers or vendors) but do not have any investment capabilities. The growth in this industry, however, highlights increasing consumer willingness for alternative finance. Thus there is still a need for higher-yielding low-risk savings instruments for consumers and for an alternative financing arrangement for vendors.

Additional prior art includes:

| Cited | Title | Filing date |
|---|---|---|
| U.S. Pat. No. 6,058,371A | Method of administering a financial instrument | May 8, 1998 |
| | having a service voucher-based return | |
| | component | |
| U.S. Pat. No. 6,161,096A | Method and apparatus for modeling and | Oct. 22, 1998 |
| | executing deferred award instrument plan | |
| US20020023026A1 | On-line savings model | Jul. 19, 1999 |
| US20020069150A1 | System and method to retain customers using | |
| | rebate in combination with investment | Dec. 4, 2000 |
| | instruments to serve customers' long term | |
| | financial needs | |
| US20020082985A1 | Method and system for converting existing or | Dec. 21, 2000 |
| | future trade credit obligations into a new | |
| | obligation | |
| US20020095365A1 | Corporate products trading marketplace | Jan. 16, 2001 |
| WO2002103469A2 | Method and system for providing enhanced | Jun. 15, 2001 |
| | forms of financial instruments | |
| U.S. Pat. No. 6,973,440B1 | Method of managing a deposit exchange to | Feb. 19, 2002 |
| | offer price reductions | |
| US20110251965A1 | System and method for varying electronic | May 24, 2002 |
| | settlements between buyers and suppliers | |
| | with dynamic discount terms | |
| US20040193491A1 | Systems and methods for promoting savings | Mar. 24, 2003 |
| | through a computer-enabled certificate program | |
| US20040262381A1 | Dynamic discount card tied to price curves and | Jun. 16, 2003 |
| | group discounts | |
| US20050222951 | Systems and methods of targeting savings | Apr. 2, 2004 |
| US20060080194A1 | Financial instruments and methods of use | Oct. 12, 2004 |
| WO2006049994A2 | System and method for supply chain financing | Nov. 1, 2004 |
| US20070112655A1 | Prepaid financial account incentives system | Oct. 28, 2005 |
| | and method | |
| U.S. Pat. No. 8,781,934B2 | Pre-paid financial savings and investment | Apr. 20, 2006 |
| | card system | |
| U.S. Pat. No. 8,732,076B2 | Methods and systems for providing a savings | Mar. 14, 2007 |
| | goal | |
| WO2009082528A1 | Method and system for reserving future | Dec. 21, 2007 |
| | purchases of goods or services | |
| WO2010011218A1 | Method of saving for a time delayed purchase | Jul. 22, 2008 |
| U.S. Pat. No. 7,725,391B1 | Savings system based on time of transaction | Sep. 29, 2008 |
| US20100138287 | Flexible Savings System | Feb. 1, 2010 |
| US20120197783A1 | Dynamic savings allocation method and | Jan. 27, 2011 |
| | purchasing model | |
| U.S. Pat. No. 8,762,230B2 | System and method for virtual piggy bank | Nov. 2, 2011 |
| | wish-list | |
| U.S. Pat. No. 8,606,713 | Computer implemented method for | Apr. 4, 2012 |
| | accumulating money | |
| US20090063332A1 | Flexible automatic savings programs | Aug. 29, 2007 |
| US20050222951A1 | Systems and methods of targeting savings | Apr. 2, 2004 |
| WO2015077689A1 | User controlled collaborative aspirational | 11/24 |
| | savings social network system and method | |

### BRIEF SUMMARY OF THE INVENTION

A method for the trading and accessing prepaid conditional value contracts (“PCVC”) between a consumer and a merchant (primary market) and/or between other consumers (secondary market). PCVCs can be for recurrent transactions (such as subscriptions) or single purchases with a targeted time-period. The term ‘discount’ is used in a general sense and includes a positive rate of return (interest, yield) on the prepaid value accrued by consumer and presented by the merchant as savings off of purchases.

Interfaces on the platform produced for the consumers and merchants allow for the execution and trading of such vouchers as well as for associated functionality.

The merchant interface possibly includes but not limited to abilities such as creation of sets of return schedules (and/or general pricing rules) targeted at particular customers or otherwise, review of outstanding inventory of PCVC assets and liabilities, as well as tools allowing for adjustment of value after issuance of original PCVC (in line with agreed upon disclosures).

The consumer interface possibly includes but not limited to abilities such as transfer digital cash into and out of the system, the establishment of a customizable consumer profile (including budgeting for events, gifts for others, and/or shopping preferences), PCVC transactions (to be elaborated on within this document) as well as inventory and details, the formulation of a rating score, linkage to a social network, and an array of interface templates.

### BRIEF DESCRIPTION OF THE DRAWINGS

The present invention is illustrated by way of example, and not by way of limitation, in the figures of the accompanying drawings in which:

FIG. 1 shows an example, according to one embodiment, of a permutation of the return schedule for a Prepaid Conditional Value Contract (“PCVC”) with a single purchase with a targeted time-period.

FIG. 2 shows an example, according to one embodiment, of a permutation of the return schedule for a PCVC for a recurrent transaction (e.g. a prepaid subscription). The per month breakdown is on the left whilst the cumulative breakdown is on the right.

FIG. 3 shows a schematic diagram, according to one embodiment, of a possible schematic for the platform as well as the related connectivity to vendor and consumer.

FIG. 4 diagrams a possible database that the platform would manage. This database stores data for the vendors and consumers with varying overlap of shared access.

FIG. 5 shows a schematic diagram, according to one embodiment, of the functionality and options available on interfaces for vendors of the platform.

FIG. 6 presents a flow diagram of an example of the process by which vendors issue PCVCs in reaction to market changes.

FIG. 7 presents a flow diagram of an example of the limited release of PCVCs by vendors and their relative value to consumers.

FIG. 8 shows a schematic diagram, according to one embodiment, of the functionality and options available on interfaces for consumers of the platform.

FIG. 9 illustrates a flow diagram, according to one embodiment, of the allocation of portfolio of funds, including financial assets and liabilities and claims to financial assets, on the consumers' interface

FIG. 10 illustrates a flow diagram, according to one embodiment, of the transference of financial claims to various divisions of a consumer's interface and to related parties within and outside of the platform.

FIG. 11 presents a is a flow diagram, according to one embodiment, of the information that consumers can modify to alter their profiles and qualities of the consumer experience that can be modified through templates or “skins” of the interface

FIG. 12 illustrates a flow diagram of the functionality, according to one embodiment, available to consumers of a method of trading and accessing PCVCs.

FIG. 13 shows a flow diagram of an example for the types of factors used by the platform, according to one embodiment, for creating a rating score for consumers in the system.

### DETAILED DESCRIPTION

The Figures (FIGS.) and the following description relate to preferred embodiments by way of illustration only. It should be noted that from the following discussion, alternative embodiments of the structures and methods discussed herein will be readily recognized as viable alternatives that may be employed without departing from the principles of what is claimed. Accordingly, the specification and drawings are to be regarded in an illustrative rather than a restrictive sense.

PCVC Characteristics

A Prepaid Conditional Value Contract (“PCVC”) is a method to provide a high-yield savings opportunity to consumers through formal contracts with vendors. By integrating targeted brand marketing and a long-term customer loyalty program, both consumers and vendors can lower expenses and more effectively manage assets, liabilities, and cash flows. The structure of the method is such that economic incentives arise for both parties. For the consumer, a discount more than covering the time value of money and an option to use the funds for unplanned occurrences, while for the merchant side, there is a mechanism to control cash flows and to market directly to targeted consumers and their social networks without creating ill will or sunk marketing costs. While discounts and rebates cheapen the shopping experience, returns on the other hand, elicit a stable investment approach; the concepts of ‘selling at a discount’ and ‘earning a return’ will be used interchangeably herein as they are different ways of describing the same process.

The characteristics of the PCVC's discount (such as magnitudes and their timings) are outlined on “return schedules” which are set at the vendor's discretion ex ante sale of individual PCVCs. There can be different permutations of return schedules to suit the needs of consumers and vendors in changing environments. The return schedule, that is at least partially predetermined and known to involved parties, details the amount that the consumer will be entitled to on future spending according to the schedule timeline (down to a range or a specific month, week, day, hour, etc.) with that vendor (or associated vendors or subsection of the vendor's offerings). Two possible permutations are single purchases with a targeted time-period and recurrent transactions (e.g. subscriptions).

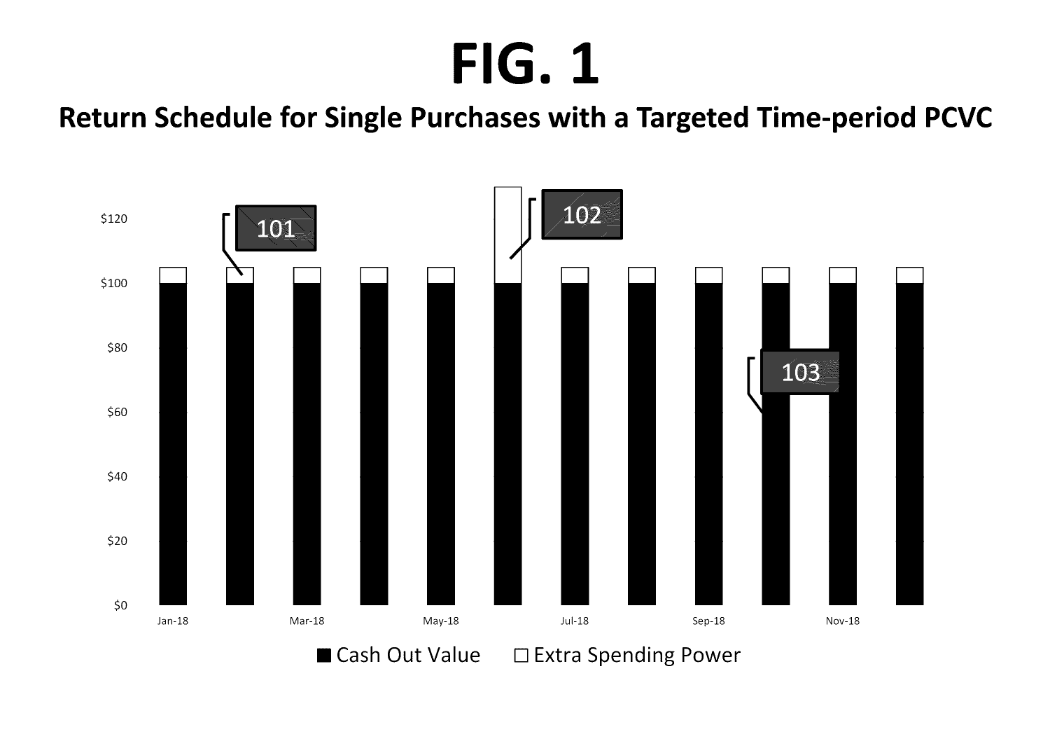

FIG. 1 is an example of the return schedule for a single purchases with a targeted time-period PCVC. The consumer is able to purchase the PCVC on the platform from a vendor (the Merchant) by prepaying funds at time zero (Jan. 1, 2018 in this example) for $100 and committing to use those deposited funds to purchase from only that vendor at a future date. Depending on whether the PCVC is used at the vendor 101 or any other way (at another vendor or cashed out) 103 the value of the PCVC (or conversely the value of the discount) changes with time. The single purchase PCVC has at least one (targeted) period with a large return in order to incentivize the consumer to purchase the charm now and use it during the target period 102. In this example, the customer is able to purchase up to $130 worth of goods with the original vendor during the month of March 2018 102, $105 worth of goods with the original vendor during any other month 101, or cash out at any time to receive the original $100 deposit 103.

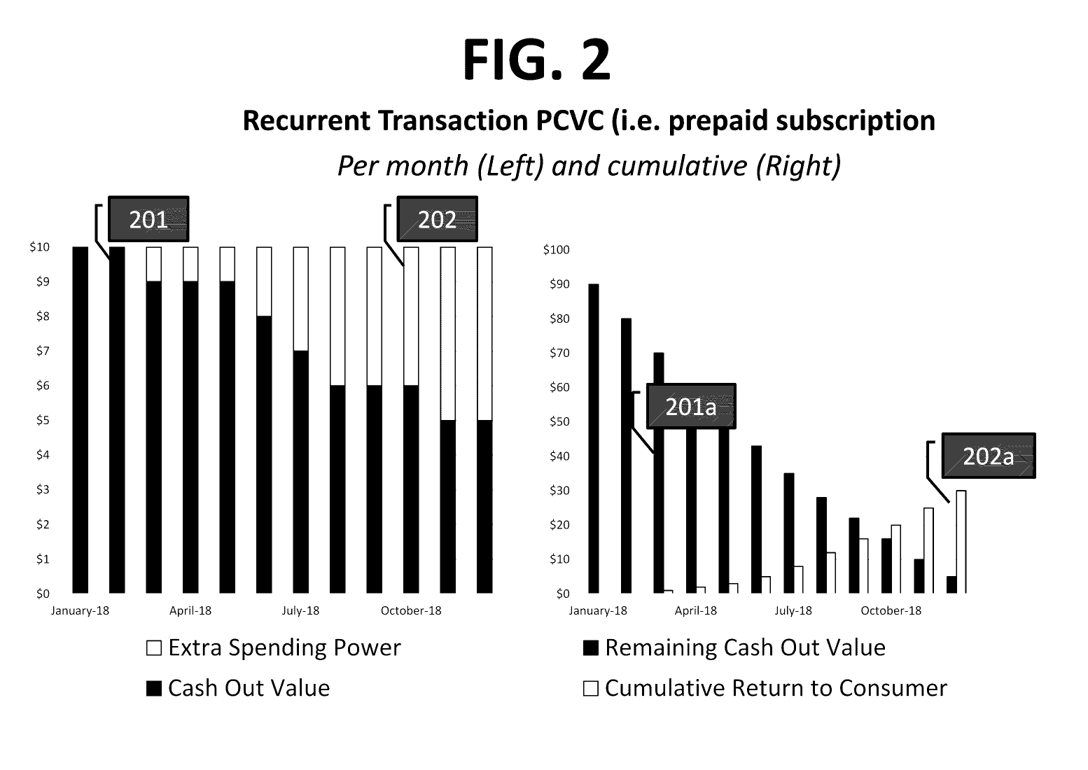

FIG. 2 is an example of the return schedule for a recurrent transaction PCVC. In this scenario, the rates of return get higher over time, motivating consumers to hold on to the PCVC and not cancel the subscription with the merchant or to cash out the PCVC. Moreover, seeing the total return may motivate a consumer to prepay for the entire subscription period (a year in this case) instead of paying monthly. The discount in this permutation is, in a sense, amortized over several period. In this example, the customer pays $90 up front and has $120 worth of spending power with that Merchant—or a year's worth of $10 service per month. In the first period (month in this example), the vendor deducts $10 from the value of the PCVC 201 and the PCVC retains $90 201a. The latter amount of $90 can be cashed out by the consumer to cancel the PCVC. For each subsequent period the vendor covers an increasing portion of the $10 202 and the PCVC's cash out value decreases for the consumer; the cumulative discount 202a is greatest at the end of subscription, in this example, when the remaining cash out value is least.

For recurrent transaction PCVC, in one embodiment, consumers are able to shift periods forward. In other words, the consumer may put the vendor's service on hold for the period of a month and then restart the subscription continuing at the latest rate. This ability would be dependent on the vendor and the shift may be limited (i.e. one period per shift, one shift per charm, etc.). The shifts give vendors the ability to retain consumers in situations when the consumers may have cancelled subscriptions. If these shifts did not happen, the overall discount to consumers would be greater as the discount grows over periods. This method would also allow consumers to buy multi-period packages and then order from the vendor during periods they please—the amount for each period credited and deducted from that PCVC.

The rate of return (or discount) may be decomposable to or built-up from a number of factors. These can include the intended holding horizon of the contract, the number and timing of return spikes, the narrowness of usage period (i.e. are the return spikes in a single month, intraday, or day specific?), and other factors. Moreover, it should be noted that these interest rates are autonomous in that they are not related to the general economy and are decided upon by vendor. This is different from competitor products where a compounding fixed interest rate (similar to a savings account) grows the value of funds regardless of time period that the sale happens during.

The base denomination per contract (initial purchase value) can be a fixed value (i.e. $50), a range of fixed values (i.e. $50, $100, $150), or a consumer defined amount. The return would then accrue unto to that amount as defined by the schedule. These contracts can be additive (i.e. can purchase multiple contracts for the same retailer at different times and use them at the same time) while keeping their original rules and discount characteristics. In other words, consumers may have the ability to continue adding to an establish PCVC position over time through additional purchases from the same vendor (although the “return schedule” will change as time passes). The total amount can then be used on a single purchase (or not). Each contract may be divisible (i.e. can use portions of an original purchase at different times) or may be indivisible (i.e. need to be completely used in full with no remains or ability to cash out portions).

Depending on the vendor, PCVCs can be applied to purchase anything sold by the merchant and/or they can specified (by product segment, location, etc.). In one embodiment, the vendor can segregate what the PCVCs can be applied to (i.e. not to already discounted products or on video games) or the vendor can issue multiple PCVCs each one specific to a category (i.e. Vendor X—video games, Vendor X—kitchen appliances, etc. where each category has a different structure). In another embodiment, a single contract may contain more than one “return schedules” according to characteristics of the final purchase (i.e. online vs. offline, Vendor X vs. Vendor Y, Kitchen appliances vs. video games, discounted vs. full price, etc.). It may be possible for the vendor to allow for the PCVC to be used at another vendor and receive some other discount, but this is at the vendor's discretion and may be noted in the PCVC's details.

Platform

All PCVCs functionality is routed through the platform, managed by the platform administrator. The platform acts as a marketplace connecting consumers and vendors for all PCVC related transactions. The general set of vendors on the platform is approved by the platform administrator based on demand, likelihood of contract repayment, the limitation of executing the discount (i.e. if the consumer will be able to purchase anything at the store or only a subset), and other factors.

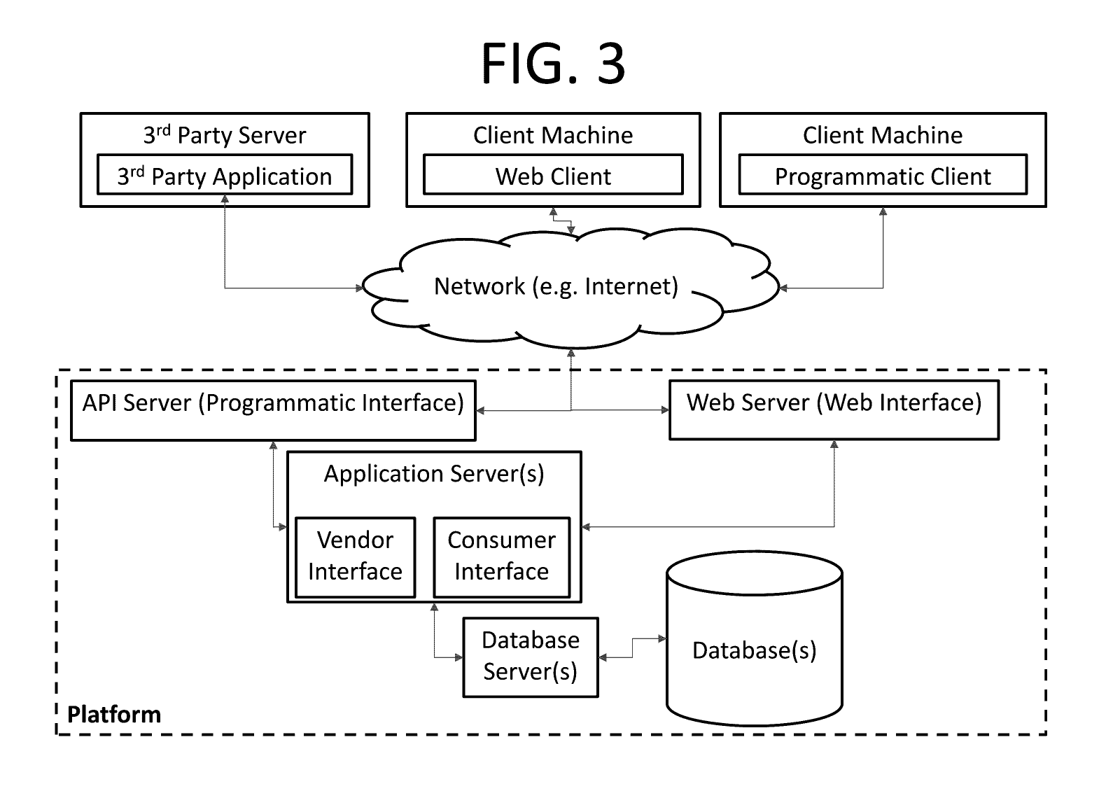

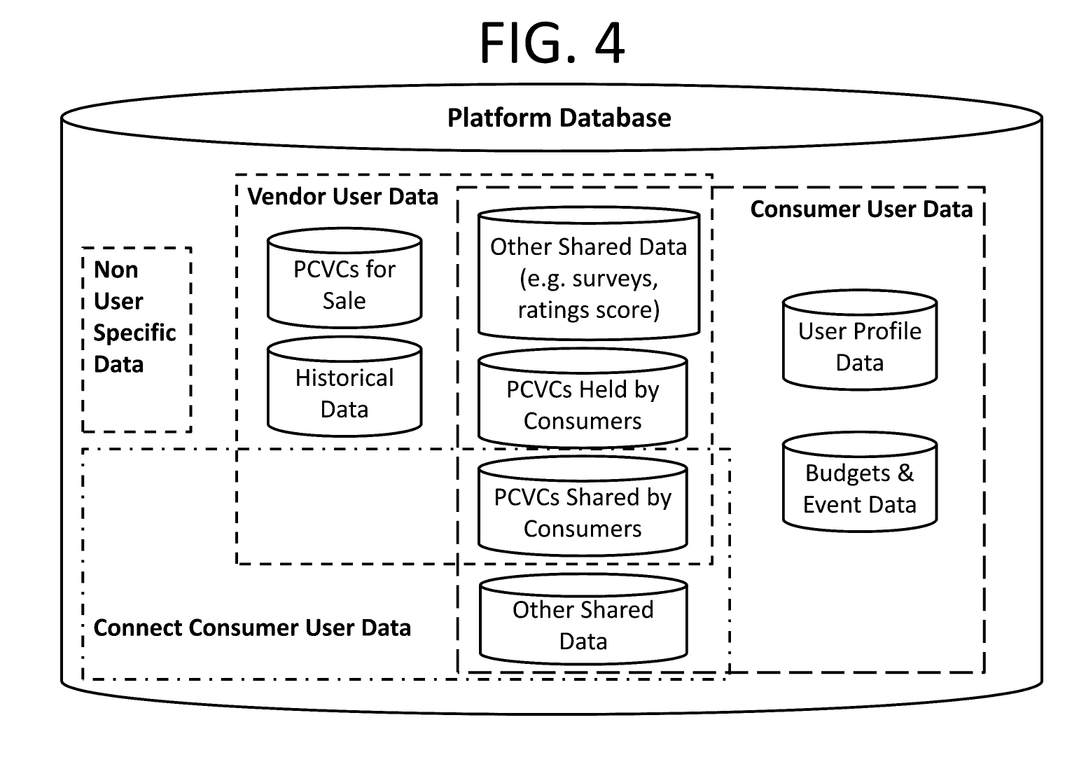

Consumers are able to access platform through several points, including but not limited to the platform administrator's web presence, partner vendors' web presence (through platform APIs integrated therein), and partner vendors' physical locations. In various possible embodiments, FIG. 3 diagrams a possible schematic for the platform as well as the related connectivity to vendor and consumer. Furthermore, FIG. 4 diagrams a possible database that the platform would manage. This database stores data for the vendors and consumers with varying overlap of shared access.

Vendors and consumers have interfaces with different functionalities. It may be possible for entities to act as vendors in certain instances and consumers in other instances. Hence, these entities would have access to the functionality of either interface but for separate transactions.

Vendor Perspective & Interface

Using PCVCs vendors are able to discount any time period (time of day, day of week, week of year, etc.) or types of product. Vendors may also be able to gain information directly from future shoppers. They can survey target consumers that have displayed relevant interest in their budgets and compensate them with free or heavily discounted PCVCs. There are several benefits that vendors may expect from using PCVCs over other types of promotion.
a. Unlike coupons, vendors are able to actively manage discount to increase purchases for a particular time period. The magnitude/timing of the discounts is controlled by the company and is a function of cash need; due to the discount control and ability to disperse rates, public information leakage is diminished and menu costs are minimized and contained.
b. The ability to manage sales risks allows firms to smooth out cash flows are decrease exposure to the business cycle. Steadier sales allow for more predictable cost management—improving supplier & employee relations as well as the retail experience. Academic empirical analyses have demonstrated that stock prices behave as if the unearned revenue liability (i.e. prepaid subscriptions, gift cards, and PCVCs) represents an economic asset; the valuation of this asset is also negatively related to the variable costs of production and further decreases firm risk.
c. Pre-payment has also been linked to reduced delinquency risk. Reliability of payment is certain since revenue realized at time of transaction (unlike with credit cards). Furthermore, customers may return less merchandise if they plan for purchases unlike with impulse purchases which are encouraged through random promotions.
d. Vendors gain access to short-term financing to better manage working capital. Deferred (unearned) revenue can function as a short term loan allow the merchant to better manage working capital (by altering discount) and target future consumers directly. Stores can change the discount rate on future prepaid contracts based on when they need cash. As was seen during the credit crunch, banks will not always offer cheap cash.

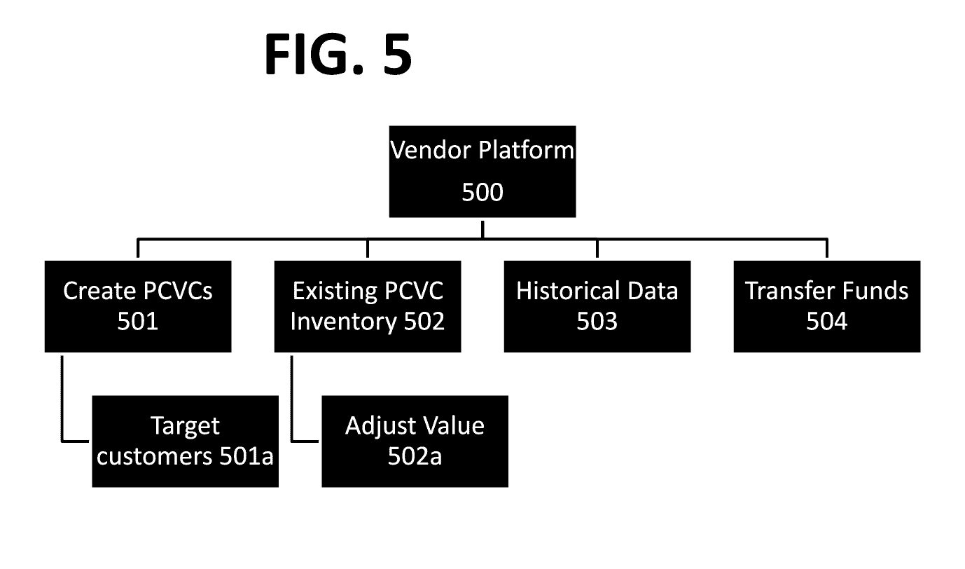

In various possible embodiments, FIG. 5 diagrams a host interface for vendors 500. Vendors may be able to create new PCVCs by identifying the characteristics and availability of return schedules (i.e. how many of each type may be sold at a given time) 501. Vendors may provide the platform administrator host a variety of data, ranging from sales histories to a list of time periods and maximum discount rates for which sales are required. Variables for deciding discounts and timing can include a list of factors, including weather, economic measures, and demographics. These can be combined with analytics such as econometric techniques or qualitative methods.

Vendors may target the consumers they wish to market certain PCVCs to 501a based on consumer profile (shopping preferences, demographics, location, consumer's platform ratings scores, etc.), by requiring activation through external marketing (i.e. special codes received by visiting the vendor's physical location), and other types of targeted marketing.

Vendors can review their outstanding inventory of PCVC using various filters (such as the PCVC characteristics, consumer demographics, etc.) 502. Vendors may also have tools for adjustment of value of outstanding PCVCs that have not been exercised (in line with agreed upon disclosures) 502a. As vendors acquire new information about their business, they may choose to issue incentives to change certain PCVC characteristics and stimulate consumers to delay or accelerate purchases or even to cash out. Additionally, the interface may allow vendors to analyze trends of historical PCVC activity 503. Possible analyses may investigate relationships between consumer interests (as well as exercise of PCVCs versus cashing out) and return schedule characteristics. Finally, vendors may be able to transfer certain funds to/from the platform administrator 504.

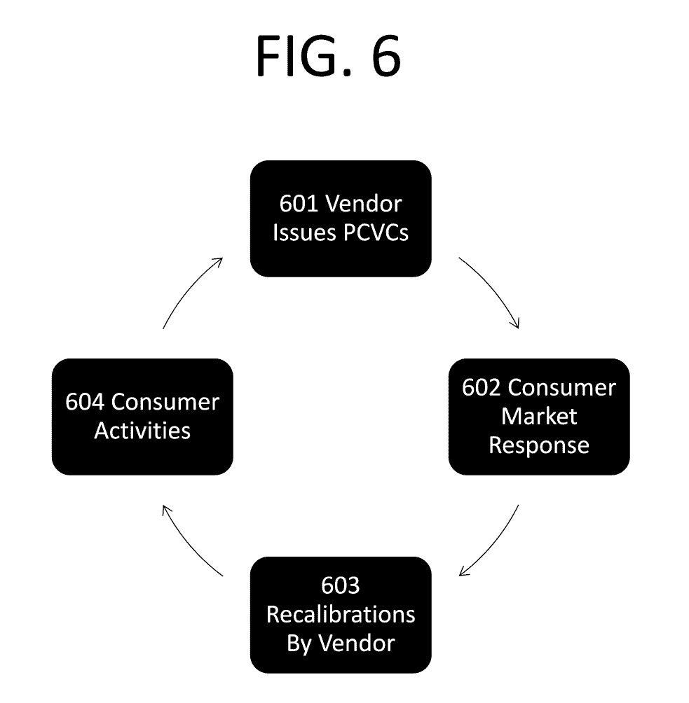

In various possible embodiments, FIG. 6 diagrams a cycle for PCVC issuance by vendors and use by consumers. The first step is for vendors to issue a set of PCVCs 601. Over time consumers will respond to the available PCVCs 602 by buying more of some and fewer of others. Based on the vendors' specifications, the set of PCVCs will be recalibrated using market data 603. This may include altering unsold issues (retiring or changing their characteristics, such as discount rates) or changing purchased PCVCs that have not been exercised (by issuing incentives to change characteristics and stimulate exercise delays or accelerations or even cash outs). Consumer actions 604 will also affect the outstanding PCVCs, perhaps by cashing out or by not exercising purchased PCVCs at all. Unexercised PCVCs may remain on the consumer's account or be transmitted back to them in whatever way possible. The cycle will continue where vendors issue PCVCs according to mix of outstanding issues and sales goals. In the embodiment that consumers are able to trade PCVCs on a secondary market, that market is viewed as ‘consumers’ by the vendor and the characteristics of that market are another variable in the vendor's decision making strategy.

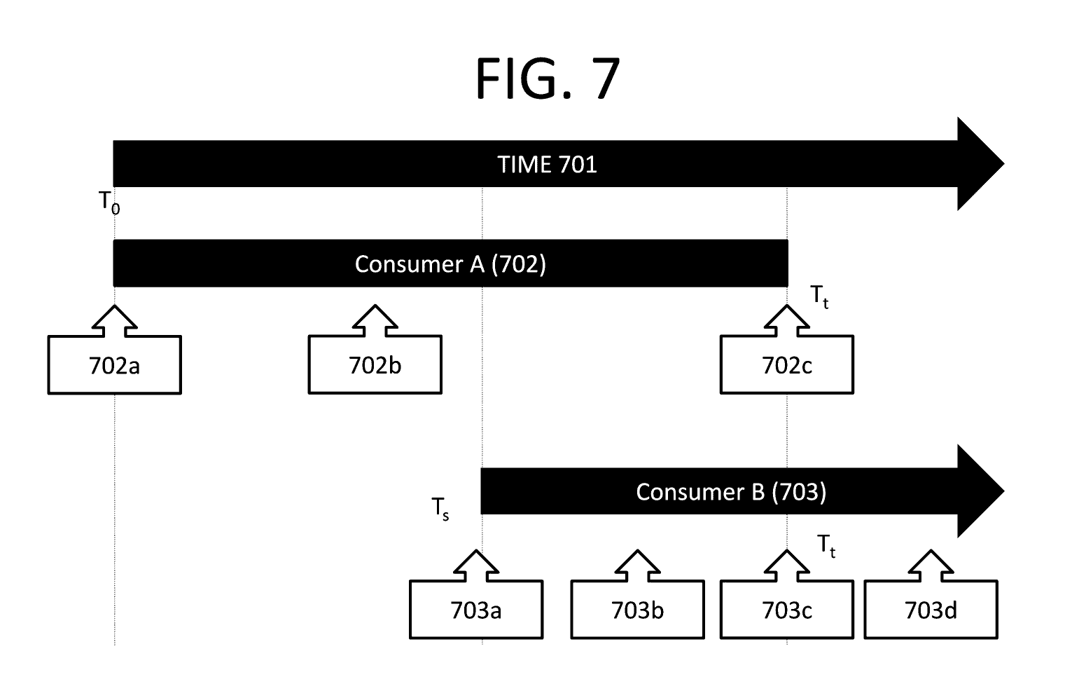

In one embodiment, PCVCs that are available to all consumers can be sold on a “first-come, first-serve” basis representing limited releases of PCVCs with given discount magnitudes. FIG. 7 is an example of the types of changes that may happen over time to the value of PCVCs. Consumer A 702 bought a PCVC from a given vendor at time T₀ 702a. Consumer B 703 bought another PCVC from the same vendor at time Tₛ 702a such that time Tₛ is later than time T₀. As Consumer A purchased the PCVC before Consumer B, Consumer A has a better rate since the supply of PCVCs is such that better return schedules are limited and distributed on first come, first serve basis (holding all else constant). Consumer A and B may have improved return schedules, 702b and 703b, respectively. This may result from upgrades to schedules that are surprise, unpredictable, variable, and/or targeted. These “lotteries” can vary in timing and magnitude and occur during voucher exercise or to influence the exercise timing and/or contract characteristics (i.e. limiting usage by adding a lock). At time T_{T}, Consumer A cashes out her PCVC 702c. In one embodiment, Consumer B is next in line to receive the preferred return schedule of Consumer A (703c then will be valued higher than 703b, perhaps at 702b, the sum of 702a and 703b, or another rate) as a way of incentivizing immediate purchase of PCVCs to get in line for sold out PCVCs instead of waiting for better terms. After this, additional rates improvements may be added 703d. In other words, consumers may be automatically entered into a queue where in consumers are upgraded to PCVCs with superior return schedules that were not in stock during original purchase but have become available either as a new batch release by the vendor or from cash outs by other consumers.

Consumer Perspective & Interface

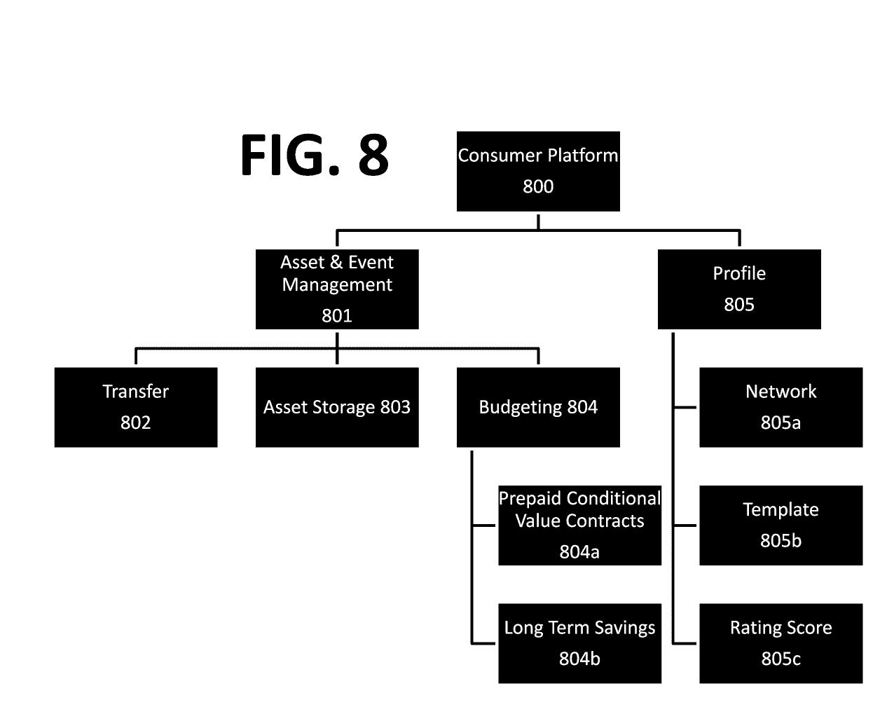

In various possible embodiments, FIG. 8 diagrams a host interface for consumers 800 that allows consumers to manage assets using the method contracts of the system 801. Management includes but is not limited to transferring digital cash and or contracts into and out of the system and to among consumers 802, storage of digital cash and or contracts on the system 803, and the creation of budgets 803 (either independently or in tandem with others). Budgets are funded via the purchase of contracts for events 804a or for long-term savings 804b. The contract involves a method for the acquiring and accessing PCVCs between a consumer and a vendor. Additionally, the interface allows for the establishment of a customizable consumer profile 805, a linkage to a social network 805a, an array of interface templates 805b, and rating score information 805c.

Consumers may enter into contracts without or without associated events. Consumers may also categorize and direct future (new or additional recurrent) funding of events with or without currently funded contracts. In other words, if a consumer plans ten events, she can order the preference in which they are funded in the future.

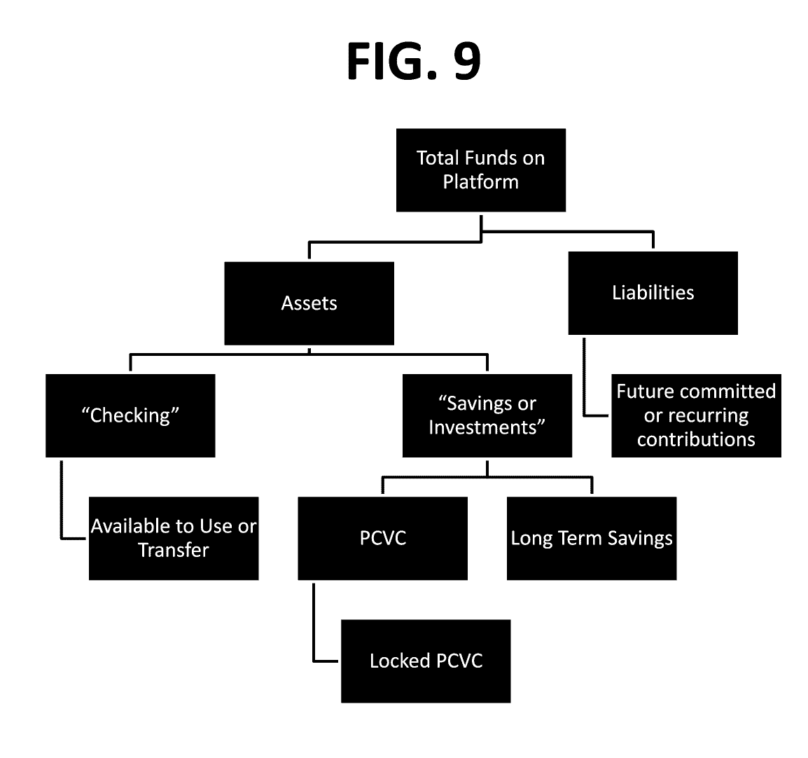

A balance sheet-type view of the total funds on the consumers' interface split into assets and liabilities can be seen on FIG. 9. As the contracts represent economic assets, the total funds on the platform can be thought of as an investment portfolio with some liquid assets (digital cash) and less liquid but potentially higher yielding PCVC contracts. Consumers that are willing to plan out future spending are effectively structuring a set of yield earning goal-oriented savings. The savings horizon may include a range of durations, including short (i.e. groceries, pharmacy, etc.), medium (i.e. gifts, electronics, etc.), and long-term (i.e. retirement). Locked PCVCs are further discussed in the following section. Long-term savings are not for retail spending and may not be PCVC-based so they may be automatically directed towards appropriate programs inside or outside the platform.

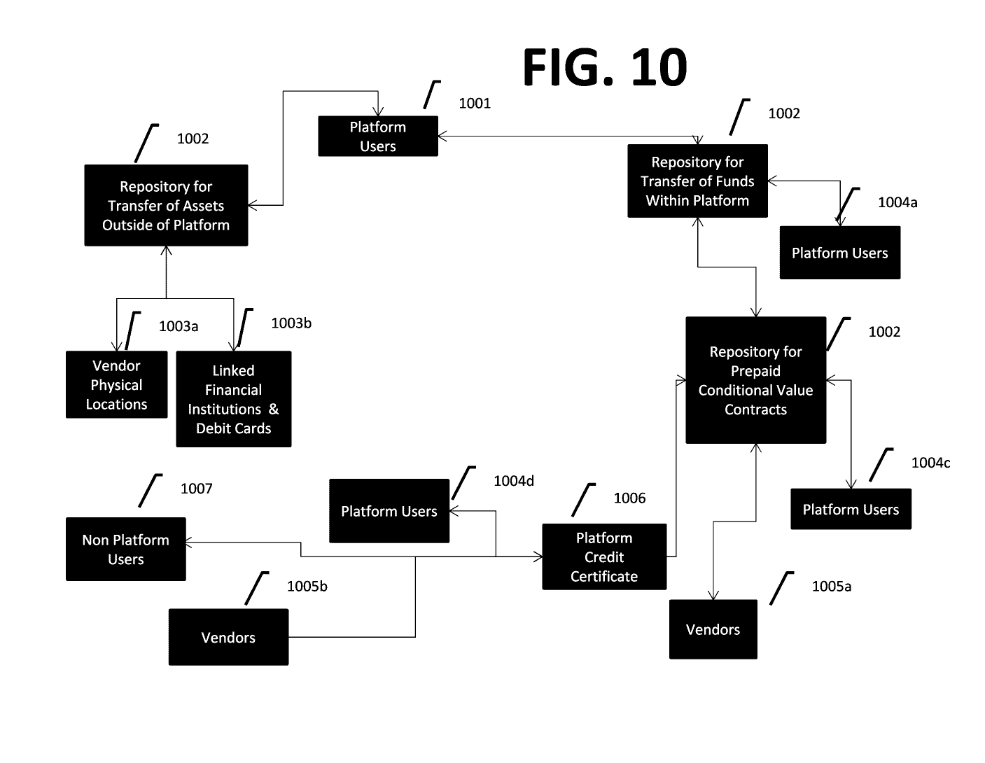

Consumers may access the platform through several points, including but not limited to: vendor websites, vendor digital application (on smartphone, tablet, or other device), and vendors' physical locations. FIG. 10 illustrates this transference of funds.

Funds may be transferred into or out of the consumer's account 1001 from either outside or within the platform via the consumer interface. All of the transfers pass through various secure repositories that log and inspect the transfers 102. Outside the platform, the consumer (or surrogate) may deposit cash (at vendor physical locations 1003a) or through linked accounts with financial institutions and debit cards 1003b. Within the platform, consumers can transfer funds through paired accounts on the interface without commitments 1004a or PCVC from other consumers 1004b or directly through or from vendors 1005a. PCVC funds can further be transferred using platform credit certificates 1006 that are generated either through the consumer's interface 1004d or a vendor 1005b, forming a unique code (e.g. barcode or QR code). These codes can be transferred by consumers or vendors to anyone with 1004d or without 1007 a consumer profile, through a digital (i.e. email, text, or other) or physical (i.e. print-out, gift card, or other) format that can be entered electronically into an existing or new consumer account on the platform.

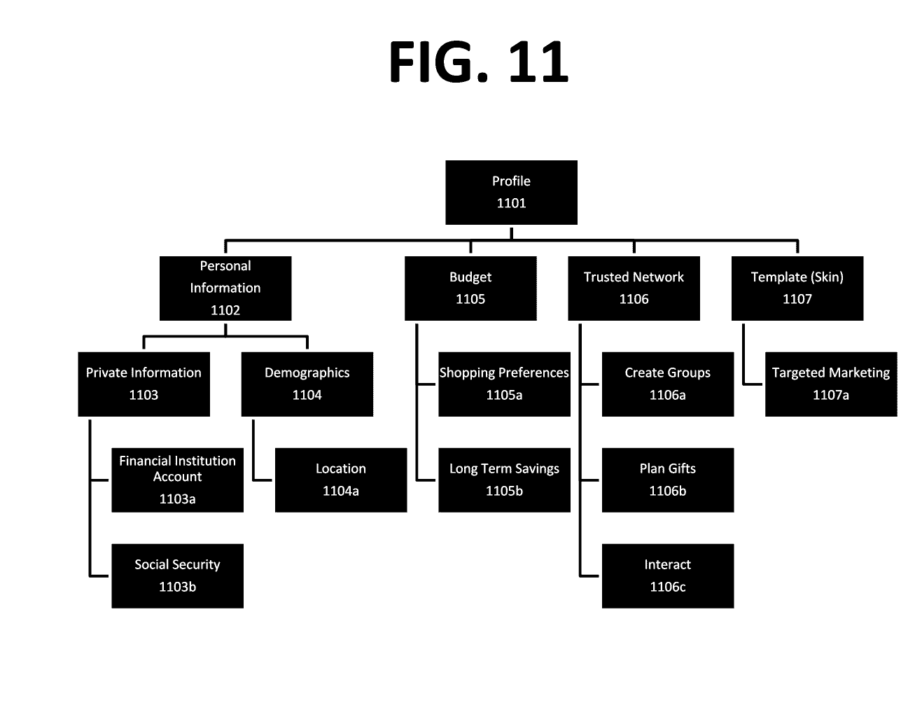

Consumer profiles are integral part of the consumer's experience and allow for enhanced connectivity to the consumer's network and vendors as FIG. 11 illustrates. Consumers 1101 have the ability to add personal information 1102 for different reasons. Private information 1103 can include financial institution account information 1103a for the ability to deposit and withdraw funds and social security-type information 1103b for ability to receive government aid. Demographic information 1104 can be used for targeting promotions/marketing by vendors, including consumer location 1104a for local deals.

Consumers may have the ability to map out general spending goals 1105. Goals may be for purchases for herself as well for others, along with target dates to spend on. Once the budget is made, the consumer may visualize spending goals (either total or netted with current savings) in different ways, including decomposed by category and on a time line of when cash flows are expected to happen. Consumers may identify holidays, special days, product launches or just save up for select spending categories, vendors and/or products within their budget. Shopping preferences 1105a can be distinct from the consumer's budget and can direct preferences for gifts by network connections (in which case they become wish lists) and targeting by vendors. Finally, the consumer can elect to automatically deposit and direct portions of future spending for long-term savings goals 1105b, such as retirement or educational savings.

Consumers can create groups 1106a within their network based on trust, affinity, or membership 1106. For example, family members, PTA members, and relations to buy gifts for are possible groups. For that last aforementioned group, consumers can plan gifts 1106b for various occasions with the information presented in each connection's gift preferences (1105a) and either plan to purchase the gift at a later date (entering a reminder in the budget 1105) or by purchasing a PCVC ahead of time and scheduling a transfer. Additionally, consumers are able to interact with their network 1106c by post messages on their profile or sending messages to a specific consumer or group.

Finally, consumers are able to personalize their experience and profiles through interface templates (“skins”) 1107. The template, visible to both consumer and her network, can have different themes that control the ‘feel’ of the interface including the colors, fonts, and application icon. Templates can be parts of targeted promotions 1107a by vendors and benefits such as promotions, deals or branded video games.

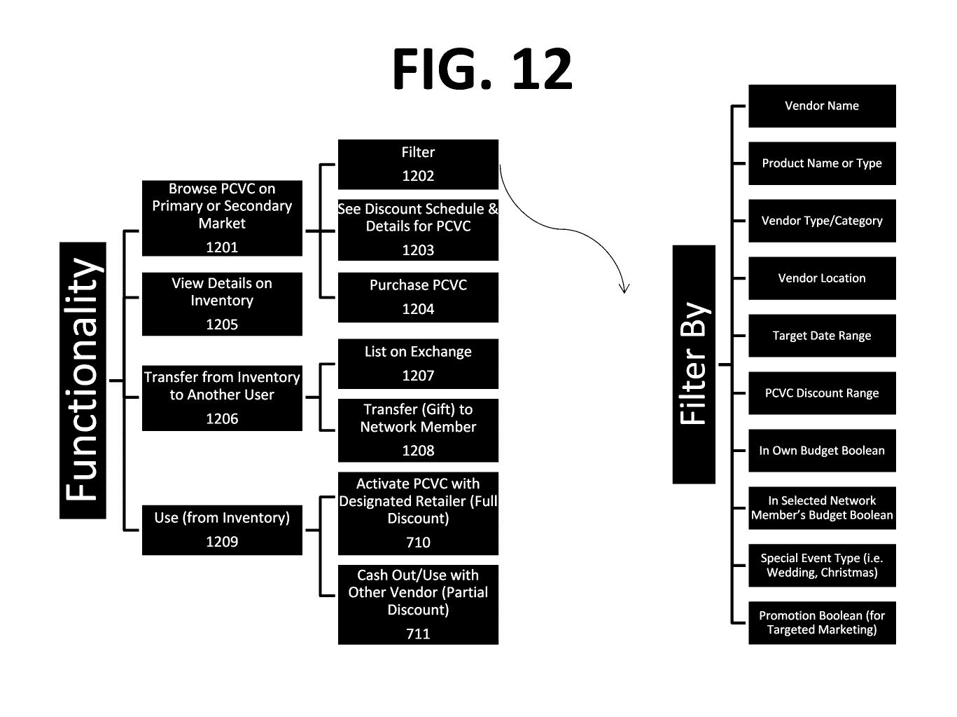

FIG. 12 illustrates some of the functionality that the consumer has with PCVCs. Consumers may be able to browse or search for PCVCs on primary and/or secondary markets 1201 after budgeting (i.e. adding an event) or by purchasing without a budget. There may be a variety of ways to filter 1202 through the available PCVCs [see sample ways in FIG. 12], visualize the “return schedule” and details (i.e. if can be used at other vendor) for each one, and the ability to purchase 1204.

Upon owning one or more PCVCs (either through purchase or by receiving as a gift), the consumer will have an inventory. She can review the details of her inventory 1205, including a list of vendors, amounts, “return schedules”, details, and any notes that she may have associate (i.e. if she budgeted this as a gift for someone). In one embodiment, consumers may designate the likelihood of use of PCVCs in their inventory. Consumers may have knowledge of which contracts they're more or less likely to activate (or cash out) and do so in order to optimize impact on rating score. Options may include [certain, likely, unlikely, or a percentage between 0 and 1] and the consumers can set during initial event creation, time of contract purchase, or any time after. Changing intended future use status, even if modified again after, can provide information for both parties. The user may identify the intended use of cash outs, such as rent/mortgage, medical, or pet expenses.

The consumer may transfer PCVCs from her inventory 1206 by listing it on an exchange (secondary market) 1207 or by transferring it (as a gift, collateral, etc.) to a network member 1208. The ability to list on the exchange may be based on the type of PCVC; so consumers may not be able to resell Targeted Marketing PCVC. The consumer can use PCVCs in her inventory 1209 by other activating/executing them with the designated vendor and receive the full discount 1210 or by cashing out/using at other vendor and not receiving the full discount 1211. The Cashing out 1211 will lead to a lower value to the holder than would selling it on the exchange 1207, but there may be no willing buyers so it may be the only option.

One embodiment that may augment the transferring ability (in particular between consumers) is that of “locking.” Locks can be either for the full or partial amount of the transferred value and can only switched on by the donor. The transferred funds (can be a direct digital cash or a PCVC) can only be used by the recipient when activated by unlocking. The recipient of a locked PCVC or direct funds transfer is not able to use it in any way, including cashing out, transferring to another consumer, listing on an exchange, and/or executing it with a vendor. A lock can make sense when the transfer or gift is conditional on some future event (i.e. if receiver graduates high school). Another embodiment of the lock is PCVC-specific where the consumer and/or the vendor can restrict the execution of the PCVC to only the issuing vendor (where all other functionality is locked) for greater returns (discounts).

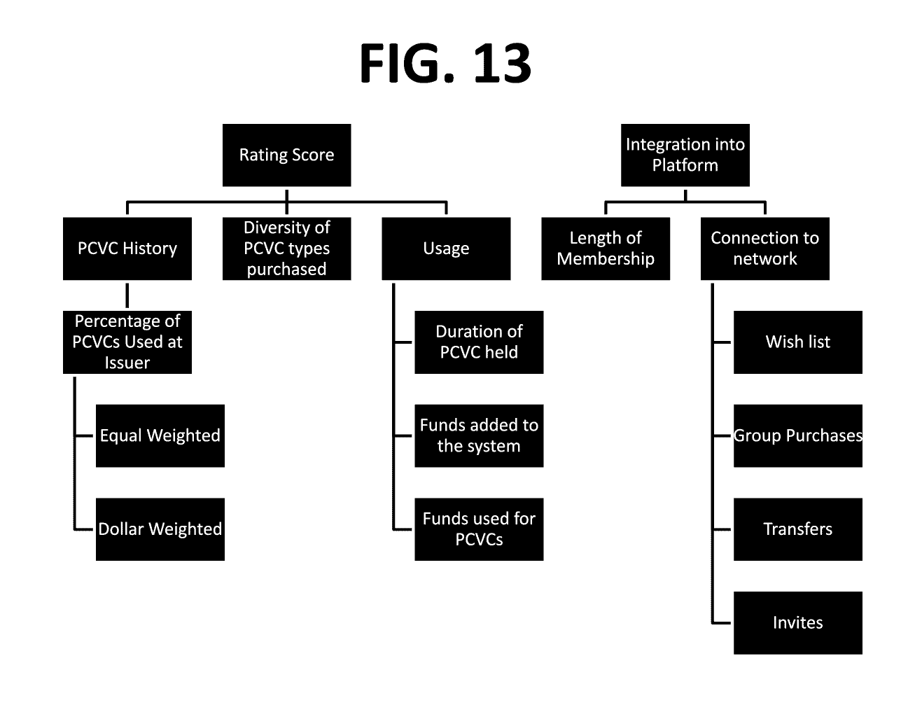

The accumulation of available data from consumers can be used to construct a rating score. Analogous to a credit score, this score and/or subcomponents of it, would measure of probability of reneging on the PCVC and may be used by vendors in targeted marketing. Consumers' desire to improve future PCVC discounts may decrease the attraction of cashing out of current PCVCs. The score can be a function of amount of PCVCs activated (amount and count), amount of planned event items (as budget or gifts), and social interactions on the platform, as illustrated in FIG. 13.

What is claimed is:

1. a method for an alternative type of financial service that provides consumers with potentially high yielding savings account-like instruments by linking them directly with the ultimate vendor, as a counterparty, in a contract with ex ante return rates that depended on when the consumer(s) receives the desired good or service. This improvement is not obvious as it hitherto has not been used in trade with or without computational technologies. By linking consumers and vendors together and structuring a time dependent contract, the current system overcomes problems for both consumers' (i.e. low return savings vehicles, few incentives to budget, etc.) and vendors (i.e., directing sale actualization time and place, immediate access to funds, gaining wallet share, etc.). The Prepaid Conditional Value Contract (“PCVC”) method is comprised of the qualities of:
an initial cash deposit transfer (or prepayment, down-payment, etc.) by a “consumer” at the onset of the contract, the initial cash transfer accessible at least partially to the “vendor” as unearned revenue (in an accounting sense, which represents a liability to the vendor of the claim by the consumer);
one or more return schedules, that are at least partially predetermined and known to involved parties, detailing the amount that the “consumer” will be entitled to on future spending according to the schedule timeline (down to a range or a specific month, week, day, hour, etc.) with that “vendor” (or associated vendors or subsection of the vendor's offerings);
characteristics of the final purchase (i.e. online vs. offline, Vendor X vs. Vendor Y, Kitchen appliances vs. video games, discounted vs. full price, etc.) may be specified initially as distinct contracts or as distinct schedules within a single contract;
a complementing, different schedule for the amount that the “consumer” is entitled to if she cancels the contract (i.e. “cashes out”), that is also at least partially predetermined and known to involved parties;
contract closing out at a time decided by the “consumer” either with activating (exercising) with the “vendor(s)” specified in the contract (or associated vendors or subsection of the vendor's offerings) or by canceling it (cashing out). Activated contracts will have a value based on the return schedules and the characteristics of the final purchase and be applied toward the purchase. Canceled contracts will follow the complementary return schedule;
the possibility of additional schedules in the form of previously unknown (random and/or variable) additions to either interest schedule upon contract close with or without additional requirements on part of the “consumer” (i.e. changes in terms and conditions, agreeing to a new schedule, etc.) that may or may not be disclosed to the consumer before the close.

2. The method of claim 1 wherein the vendor is able to offer different contracts (including but not limited to different schedules or terms) to the same consumer, set of consumers, or different consumers (or sets thereof).

3. The method of claim 2 wherein the contracts may or may not be additive (i.e. the consumer can purchase multiple contracts for the same vendor at different times and use them at the same time) while keeping their original rules and discount characteristics. Each contract may be divisible (i.e. the consumer can use portions of an original purchase at different times) or may be indivisible (i.e. the value of the contract can be used up to maximum amount according to the appropriate schedule with no remainder on the system or the ability to cash out remains or portions).

4. The method of claim 3 wherein the consumers may or may not automatically enter into a queue where in consumers are upgraded to PCVCs with superior return schedules that were not in stock during original purchase but have become available either as a new batch release by the vendor or from cash outs by other consumers.

5. The method of claim 4 wherein the consumers may or may not be able to qualify how likely they are to activate (exercise or, on the other hand, cash out) their contracts during initial event creation, time of contract purchase, or any time after initial contract purchase. Options may include [certain, likely, unlikely, and/or a percent between 0 and 1];

6. The method of claim 5 wherein the consumer is able to transfer the rights of the contract to other consumers and/or external, unregistered consumers (that then become consumers as well).

7. The method of claim 6 wherein the vendor may prohibit the transfer of the contract (i.e. use of contract by any party other than the original party) to any portion and/or type of contracts.

8. The method of claim 7 wherein the consumer that is transferring the rights of the contract may employ locks on the contract so that the contract cannot be used in any single and/or all ways (including cashing out, transferring to another consumer, and/or executing it with any vendor) until the transferring consumer unlocks the contract.

9. The method of claim 8 wherein the consumer that is transferring the rights of the contract may employ locks on the contract so that the contract can only be used with the issuing vendor (or associated vendors or subsection of the vendor's offerings) and cannot be used in any other way (including cashing out, transferring to another consumer, executing the contract with any other vendor and/or the vendor's other offerings).

10. The method of claim 9 wherein the method is part of a platform (or system) with a consumer interface including but not limited to:
an ability by the consumer to create a public profile;
an ability by the consumer to add their social network at contacts;
an ability to create a budget (i.e. wish list) and add dates to remember;
an ability to dictate access of personal budget to other consumers;
an ability to transfer funds and contracts to network members;
an ability to purchase or transfer rights to contracts for other consumers based on their budgets;
an ability to receive and/or engage in promotional marketing by vendors.

11. The method of claim 10 wherein the consumer that is transferring the funds may employ locks on those funds so that they cannot be used in any way (including cashing out, transferring to another consumer, and/or executing it with any vendor) until the transferring consumer unlocks the contract.

12. The method of claim 11 wherein a consumer has the ability to add and remove members to a group purchase (or event with multiple purchases).

13. The method of claim 12 wherein a consumer is able to personalize their platform experience and profiles through templates (“skins”), comprising:
aspects of the template being visible to the consumer and to her network;
each template having a different theme that control the ‘feel’ of the application including the colors, fonts, and application icon.

14. The method of claim 13 wherein the templates are a part of a targeted promotions by vendors and benefits such as special deals or branded video games.

15. The method of claim 9 wherein the method is part of a platform (or system) with a vendor interface that may include but is not limited to:
an ability to create new PCVCs by identifying the characteristics and availability of return schedules (i.e. how many of each type may be sold at a given time)
an ability to target classes of consumers to market certain PCVCs to
an ability to review outstanding inventory of PCVC using various filters
an ability to adjust the characteristics of outstanding, purchased PCVCs that have not been exercised (in line with agreed disclosures) to incentivize actions
an ability to analyze trends of historical PCVC activity
an ability to transfer certain funds to/from the platform administrator
an ability to alter the characteristics of unsold PCVC issues
